(19) United States
(12) Patent Application Publication
(10) Pub. No.: US 2021/0370287 A1
(43) Pub. Date: Dec. 2, 2021

(54) Tamper-Resistant Pressurized Well Fluid Transfer Bottle Having Sensor Package, Memory Gauge and Display and Uses Thereof

(71) Applicant: Halliburton Energy Services, Inc., Houston, TX (US)

(72) Inventors: Russell Stephen Haake, Dallas, TX (US); Paul David Ringgenberg, Frisco, TX (US); Adam Harold Martin, Addison, TX (US)

(21) Appl. No.: 16/965,223

(22) PCT Filed: May 10, 2018
(86) PCT No.: PCT/US2018/032090

§ 371 Date: Jul. 27, 2020

(51) Int. Cl. B01L 3/00; E21B 49/08

(52) U.S. Cl. CPC B01L 3/508; E21B 49/0875; E21B 49/088; B01L 2200/185; B01L 2200/141; B01L 2300/0663; B01L 2200/147; B01L 2300/024; B01L 2300/027; B01L 2300/14; B01L 2200/146

(57) ABSTRACT

Tamper-resistant and tamper-evident sample bottles for the transport of pressurized well fluid include sensor packages and data recording devices to characterize and track properties of the sample bottle and its contents.

### FIELD OF THE DISCLOSURE

The present disclosure generally relates to well fluid sampling and, more particularly, to a sample bottle used to transfer pressurized well fluid samples.

### BACKGROUND

When hydrocarbon exploration wells are drilled and hydrocarbon fluids are found, a well fluid test is usually performed. This test typically involves flowing the well fluid to surface, mutually separating the oil and the gas in a separator, separately measuring the oil and gas flow rates, and then flaring the products.

It is also desirable to take samples of the oil and gas for chemical and physical analysis. Such samples of reservoir fluid are collected as early as possible in the life of a reservoir, and are analyzed in specialist laboratories. The information which this provides is vital in the planning and development of hydrocarbon fields and for assessing their viability and monitoring their performance.

These samples may be collected inside pressurized sample bottles to transport the fluids from the well to the lab. However, conventional sample bottles present a number of disadvantages. Once the sample bottles arrive at the lab, various test are run on the bottles to assess the fluid/bottle characteristics, such as the pressure. To obtain this data, the bottles must be connected to pressurized manifolds. As a result, the technicians are exposed to pressurized instrumentation and may inadvertently introduce errors into the data analysis process. In addition, the lab technician has no way to determine if the fluid has been contaminated during transport or if the bottle has been tampered with.

### BRIEF DESCRIPTION OF THE DRAWINGS

FIG. 1 is a three dimensional view of a sample transport bottle, according to illustrative embodiments of the present disclosure;

FIG. 2 is a sectional view of a sample transport bottle, according to certain illustrative embodiments of the present disclosure; and

FIG. 3 is a flow chart 300 of an illustrative method of the present disclosure.

### DESCRIPTION OF ILLUSTRATIVE EMBODIMENTS

Illustrative embodiments and related methods of the present disclosure are described below as they might be employed in a sample bottle for the transfer of pressurized well fluid and related methods thereof. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, embodiments and methods of the present disclosure provide tamper-resistant or tamper-evident sample bottles having sensor packages and data recording devices to characterize and track properties of a pressurized sample bottle and its contents. In a generalized embodiment, a sample bottle includes a housing having a fluid sample inlet port. A chamber is in fluid communication with the sample inlet port to receive a well fluid. A sensor package is positioned on or inside the bottle to obtain characteristic data of the well fluid in the bottle or the bottle itself (e.g., pressure integrity). A memory device is communicably coupled to the sensor package in order to store the data such that it may be displayed or otherwise communicated to a technician.

In a generalized method for use of the sample bottle, well fluid is admitted into a fluid sample chamber of the sample bottle. Pressure is applied to the well fluid in a manner which maintains the well fluid in a pressurized state. Using a sensor package positioned on or inside the sample bottle, data related to one or more characteristics of the well fluid is obtained. The data is then recorded to a memory device coupled to the sensor package.

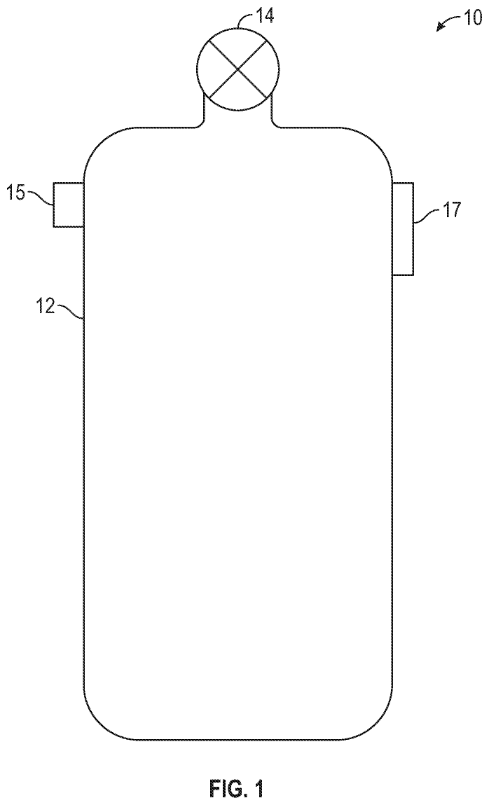

FIG. 1 illustrates a pressurized well fluid sample bottle, according to certain illustrative embodiments of the present disclosure. Sample bottle 10 may be any variety of pressurized bottles used to transport well fluids, such as those used to transfer single phase or multiphase fluids. Examples of such bottles are the Type 5 10k 700 cc sampling cylinder commercially available from Proserv™, or the Xlite™ sample bottle commercially available from IKM Production Technology AS. Such sample bottles may be used for surface or downhole sampling of well fluids. As will be described in more detail below, the illustrative embodiments of the present disclosure may be integrated with a variety of pressurized fluid sample bottles and those specific bottles described herein are illustrative in nature only.

In this simplified illustrative embodiment, pressurized sample bottle 10 comprises an externally cylindrical housing 12 having an inlet valve 14. In this example, sample bottle 10 includes an internal pressure chamber (not shown) to admit and discharge sample fluid. In other examples, sample bottle 10 may also include any number of internal cavities, chambers, valves, fluid sample inlet/outlet ports, etc. in which to admit and discharge well fluid, pressurize well fluid, etc.

The various embodiments of the present disclosure integrate sample packages, memory devices, and display modules with sample bottles in order to characterize and track properties of the pressurized bottles and the well fluid therein. With reference to FIG. 1, sample bottle 10 includes a sensor package 15 that includes one or more sensors to obtain data related to the well fluid inside sample bottle 10. Although depicted as being attached to the outer surface of housing 12, sensor package 15 may be positioned at a variety of other locations on/inside sample bottle 10. Such locations include having multiple sensor packages 15 at both end caps of a sample bottle (which includes end caps, such as a dual phase bottle). Alternatively, sensor package 15 may be integrated into the body of sample bottle 10, positioned inside a well fluid sample chamber of bottle 10, or positioned at inlet valve 14.

Sensor package 15 may take a variety of forms. Such forms include, for example, one or more embedded capacitance, resistance, piston position, pressure or temperature sensors, strain gauges, etc. specifically tailored for use with sample bottles used to transport high pressure hydrocarbon samples. The sensors may obtain data related to a variety of well fluid and sample bottle characteristics including, for example, fluid density, pressure, temperature, volume, composition, etc. For example, pressure and volume may be detected using externally mounted sensors (e.g., strain gauge for pressure and gauss meter/magnetometer externally mounted to sense the position of the floating piston (with embedded magnets)). Other variables such as resistance, capacitance, etc may be detected using sensors in direct contact with the sample fluid inside the bottle.

In certain illustrative embodiments, each sensor forming part of sensor package 15 may be battery operated (except the capacitance sensor, which is power-hungry and may be activated only while connected to a USB port or other power source external to the sample bottle) and would write to nonperishable memory (i.e., a memory device) also forming part of sensor package 15. Alternatively, however, the memory device may be located elsewhere on sample bottle 10. Also, in certain embodiments, the batteries used to power sensor package 15 may be rechargeable.

In operation of an illustrative embodiment of sample bottle 10, sensor package 15 obtains data related to characteristics of well fluid samples inside bottle 10 using, for example, capacitance sensors. These capacitance sensors may provide differentiation between oil and water at the time of sample transfer, and will provide verification of complete homogenization of the well fluid sample prior to transfer or analysis (i.e., when the rocking period is concluded). Sensor package 15 may also include position sensors which may provide data corresponding to volume measurements of the well fluid samples. In other examples, sensor package 15 may also provide temperature and pressure data used to monitor or verify bottle transfer and transportation conditions, removes possible concealment of premature flashing (dropping sample pressure below bubble point—enabling sample phase segregation), and may be used to identify leakage (if present).

Also, in certain other illustrative embodiments as illustrated in FIG. 1, sample bottle 10 may also include a display module 17 communicably coupled to sensor package 15. Display module 17 may take a variety of forms including, for example, a digital, toggle-able display to display density, pressure, temperature, capacitance (therefore composition) and position (therefore volume) of the well fluid sample inside bottle 10. Also, in certain embodiments, display module 17 also displays a battery life indicator so the remaining charge left to power sensor package 15 and display module 17 may be viewed. As a result, various characteristics of the well fluid sample and bottle integrity can be easily known at any time without having to connect a pressure manifold to sample bottle 10 (as required in conventional bottles). In yet other illustrative embodiments, each data channel of sensor package 15 may be configured to transmit wirelessly (e.g., via Bluetooth or other remote mechanism) to other processing devices remote from bottle 10 (or, alternatively, other processing devices forming a part of bottle 10).

As a result, the illustrative embodiments of the present disclosure simplify service quality assurance, minimizes risk of sample flashing, and reduces Health, Safety, and Environmental (“HSE”) exposure. Moreover, embodiments of this disclosure provide considerably more data to both the sampling technician and the ultimate end user of the sample (e.g., lab techs, petroleum engineers). In addition, the illustrative embodiments improve the ultimate value of the product delivered (sample+data) and reduces HSE exposure and error risk for the sampling technician.

As mentioned above, sensor package 15 contains a battery-powered memory device in certain illustrative embodiments. Although not specifically stated, sensor package 15 also includes processing circuitry by which to carry out the functions described herein. In such examples, sensor package 15 (and the memory device) may be installed into valve 14 or other locations along housing 12. Nevertheless, in any embodiment, sensor package 15 may be a patch-on strain gauge and/or digital thermometer adhered to the outer surface of housing 12. Alternatively, however, sensor package 15 may be integrated into housing 12 or some other location (e.g., an internal chamber, piston, etc.) of sample bottle 10.

The rate at which sensor package 15 samples the data may also be varied. In certain embodiments, sensor package 15 may receive data at some predetermined, high sampling rate (e.g., 1× per second). If the data point indicates the well fluid is undergoing a dynamic event/process (e.g., transfer), the memory device of sensor package 15 records 1× per second (or at an increased/elevated/adjusted sampling rate). A transfer is the process of either refilling or removing all or a portion of the sample contents to/from the sample bottle to a different apparatus. Transferring is generally considered “the hard part” of preserving sample quality during its lifecycle. It is by default a very manual process, requiring a skilled technician to exactly follow a complicated procedure in order to preserve the pressure of the sample at all times during the transfer. Prior to sample transfer, the sample/sample bottle will typically be reconditioned to downhole temperature conditions. As temperature is increased, the bottle pressure will rise, and would also be considered a dynamic event initiated by user intervention. The illustrative embodiments of the present invention, provide a tamper-resistant means by which to monitor the integrity of the transfer process and other dynamic events. Nevertheless, with regard to sampling speed, if sensor package 15 detects that no dynamic process is occurring (long term storage), the memory device may record at some lower sampling rate (e.g., records 1× per hour or reduced/less frequent sample rate). In yet another example, the memory device may be “dumb” configured where the data is stored at a constant rate no matter the detected activity.

The data obtained over the life of the well fluid transport process may be utilized in a variety of ways. In certain embodiments, the data may be uploaded to a remote system from the memory device of sensor package 15 via wired or wireless methods. In other embodiments, the data may be viewed on the display module 17. While in other embodiments sensor package 15 is connected to a USB port, whereby data is transferred to some remote system and a spreadsheet is generated and output which describes the data. The characteristic data included in this spreadsheet may be historical data tracing fluid/bottle characteristics back from the time the original sample is received into the bottle (e.g., from well), during transport of the sample in the bottle, to the time of analysis at the lab (spanning from days to months to years—dependent upon analysis date).

In certain embodiments, the memory device of sensor package 15 is tamper-resistant. Here, the memory device may be hard mounted at some location on/in housing 12 or some other tamper-resistant location on/inside bottle 10, for example. One example of a hard mount is the memory device may be soldered onto the printed circuit board of sensor package 15. In certain illustrative embodiments, disassembly of the circuit board would be required in order to clear the memory device, while in other embodiments there would be no way in which to clear the memory device (it would simply start writing over the oldest data once it reaches data capacity). In other embodiments, the processor may activate an audible alarm when the memory device is full. In yet other embodiments, the memory device may only be cleared when the processor of sensor package 15 detects a power input voltage that is greater (e.g., 5% greater) than the last known voltage after disconnection and reconnection (such as would be expected during specialized redress (e.g., the changing of all elastomeric seals and battery(s)). As a result, in certain embodiments the data stored on the memory device would only be clearable by dismantling sample bottle 10 and removing the hard-mounted memory device. Such a design makes the data tamper-resistant, which is a useful quality assurance tool to guarantee pressure and temperature conditions are maintained/known throughout the life of sample (i.e. original sample transfer to bottle, storage period in bottle, sample transfer during analysis). Moreover, the technicians would also be assured of the integrity of all other data (volume, density, composition, etc.) obtained from the memory device.

In addition to hard mounting sensor package 15, a variety of other features may be implemented to ensure the tamper-resistance of the described sample bottles. For example, alarm indicators may be written into the control software of the processor of sample package 15. The alarms may be triggered, for example, when a sudden change in temperature or pressure (indicating damage to the system) is detected by sensor package 15. The alarms may be LED indicators, text message alerts/status updates or codes, etc. on the display when the technician checks the bottle status. In addition, these alarms may only be overwritten/cleared if sample package 15 is completely disassembled or at the time of a specialized service (e.g., replacement of bottle parts such as o-rings or batteries). Thus, the data in the memory device of sample package 15 may never be overwritten or modified without the triggering of alarms which would then be displayed on display module 17 or otherwise output when data is downloaded from the memory device.

As previously discussed, embodiments of the present disclosure may be implemented on a variety of pressurized sampling bottles used to transfer well fluids. Below, one illustrative sample bottle will be discussed in more detail in order to further describe various aspects of the disclosure. The illustrated sample bottle, however, in no way limits the scope of the present disclosure and is described for illustrative purposes only.

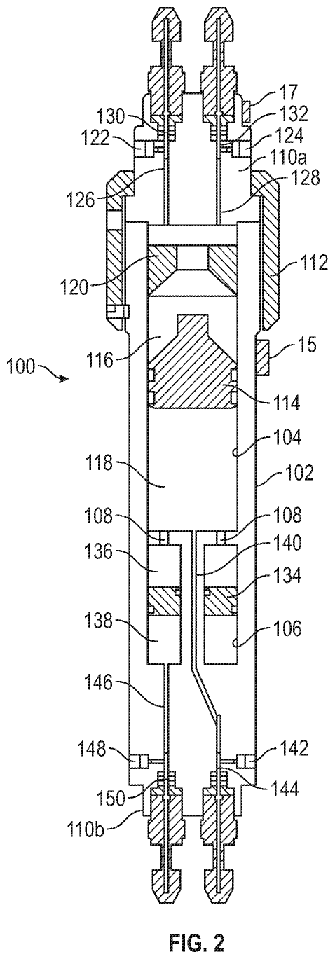

FIG. 2 is a sectional view of a pressurized sample bottle for the transfer of well fluids, according to certain illustrative embodiments of the present disclosure. As understood in the art, sample bottle 100 is intended to be used in conjunction with various types of well fluid sampling tools that are deployed downhole (it could also be used for the collection of surface acquired samples) for the purpose of obtaining the well fluid. The well fluid is then transferred to sample bottle 100 for transport and analysis.

Fluid sample bottle 100 comprises a generally cylindrical housing 102 internally divided into first and second cylinders 104 and 106, permanently mutually connected by internal passages 108. The top end of the casing 102 is closed by an end cap 110a retained on the housing 102 by a screw-threaded retainer ring 112. The first cylinder 104 is internally divided by a first floating piston 114 into a fluid sample chamber 116 and a pressurization chamber 118. First floating piston 114 is slidingly sealed to the bore of cylinder 104 in order to physically separate respective fluids in chambers 104 and 106 while substantially equalizing pressure there-between and allowing each of these chambers 104 and 106 to have a variable internal volume. An annular agitator ring 120 is loosely located in the sample chamber 116 in order to eliminate dead volume in sample chamber 116 or to improve homogenization and dissolution of solids into the sample during a period of rocking/agitation which is sometimes required.

A pair of fluid sample inlet/outlet ports 122 and 124 in the end cap 110a each communicate with the sample chamber 116 by way of a respective passage 126 and 128 which can each be selectively opened or closed by a manually operable isolating valve 130 and 132 respectively. The second cylinder 106 is similarly internally divided by a second floating piston 134 into a pressure transmitting chamber 136 and a pressurization reservoir 138. The pressure transmitting chamber 136 is permanently hydraulically connected to pressurization chamber 118 by way of internal passages 108.

A fixed central hydraulic conduit 140 passes axially through the second cylinder 106 to communicate the pressurization chamber 118 with an external port 142 in the lower end of housing 102. The hydraulic conduit 140 can be selectively opened or closed by a manually operable isolating valve 144. The external surface of conduit 140 is cylindrical and coaxial with the bore of second cylinder 106. The second floating piston 134 is annular and is slidingly sealed both to the bore of the second cylinder 106 and to the external surface of the through-cylinder conduit 140 in order physically to separate respective fluids in the chambers 136 and 138 while substantially equalizing pressures there-between and allowing chambers 136 and 138 to have variable internal volumes.

A further passage 146 in the lower end of the casing 102 communicates the pressurization reservoir 138 with a further external port 148 in the lower end of the casing 102. The passage 146 can be selectively opened or closed by a further manually operable isolating valve 150.

Prior to sample-transferring use of the sample bottle 100, the pressure transmitting and pressurization chambers 136 and 118 are primed by being filled through the external port 142 and the temporarily open isolating valve 144 with a suitable incompressible hydraulic fluid, preferably a mixture of water and ethylene glycol. This hydraulic priming of the chambers 136 and 118 is carried out with the isolating valve 150 and one or both of the isolating valves 130 and 132 temporarily open to allow the chambers 136 and 118 both to expand to their maximum internal volume, with a corresponding reduction to zero internal volume of both the sample chamber 116 and the pressurization reservoir 138.

After priming of sample bottle 100, all isolating valves are initially shut (except that the open/close state of the pressurization reservoir isolating valve 150 is immaterial at this stage). The sample port 124 is coupled to the downhole sampling tool. An external pressurization source (not shown) of highly compressed gaseous nitrogen (or any other suitable elastic pressurization source), is connected to container port 148 (i.e., pressurization source connection). To commence transfer of the sampled well fluid from the downhole sampling tool to sample bottle 100, a pump 166 is coupled to the downhole tool and inlet port 124 to force sample fluid under pressure from the downhole tool and into the sample chamber 116 in the sample bottle 100. By opening the isolating valve 144, the outflow of hydraulic fluid (water/ethylene glycol) from the pressurization chamber 118 in the sample bottle 100 can readily be manually throttled to sustain the sampled well fluid at a desired high pressure which retains the sample in its original single-phase form (if desired) or otherwise maintains/adjusts the pressure as necessary. Further operation of sample bottle 100 or similar sampling bottles will be readily understood by those ordinarily skilled in the art having the benefit of this disclosure.

In this illustrative embodiment, sample bottle 100 includes sensor package 15 on housing 102 adjacent fluid sample chamber 116. Sensor package 15 may include a variety of sensor types including, for example, capacitance or resistance sensors. The positioning of sensor package 15 allows it to measure various characteristics of the well fluid in sample chamber 116 during the life of the fluid sample. Such characteristics includes the density, volume, pressure, temperature, or composition of the well fluid, as well as the position of floating piston 114 (or other floating pistons). The memory device then samples the data at a desired rate, as described herein. Also, as previously discussed, the memory device forms part of sensor package 15 in this example; however, in other examples the memory device may be located elsewhere on sample bottle 100.

Moreover, the location and number of sensor packages may be varied. For example, in certain embodiments a sensor package may be positioned adjacent sample chamber 116 and another positioned adjacent pressurization chamber 118 or chamber 138 in order to detect pressure leaks across floating pistons 114 or 134 over the life of the well fluid sample (from transport to lab analysis). Also, in other embodiments, a position sensor may be attached to (or form part of) floating piston 114 in order to obtain volume of other measurements. Here, the position sensor may be used to determine the distance from the piston to either end cap 110a,b, and therefore the sample volume contained within. Also, this position sensor, combined with change in temperature data, would provide a rough estimate of the petroleum shrinkage factor. In yet other examples, separate sensor packages may be placed at each end cap 110a/b

Moreover, the embedded/integrated sensor package design could be installed at either end of sample bottle 100. Installing it on the sample side (adjacent sample chamber 116) provides more benefits as described above (direct measurement of sample conditions—pressure, temperature, capacitance etc). Installation on the other side of the sample bottle adjacent chambers 118 or 138 (exposed to the compensating/pressurization fluid—typically a pressurized gas volume, such as nitrogen, serving as a compensating “spring” to maintain pressure through various possible disturbances during transport and storage such as temperature changes or mechanical shock) could provide evidence of compensating fluid leakage/contamination into the well fluid sample.

Therefore, in certain illustrative embodiments, sensor package could be positioned adjacent the sample chamber (such as an external strain gauge for pressure extrapolation via housing strain) or embedded within either end cap of the bottle and hydraulically communicated to the sensor package(s). Also, the sample bottle could be instrumented with multiple sensor packages of varying responsibility/measurement. For example, a dedicated pressure sensor could be instrumented to monitor/record the pressurization source (e.g., N2). Monitoring N2 pressure on the bottle, could tell you for example that the N2 isolation/communication valve is faulty, and would thus alarm operators to discard use of the bottle prior to sample transfer. Further, having pressure sensors monitoring both the N2 pressure and sample pressure would provide operators the necessary information to identify the source/location of an N2 leak—for example, through the N2 Isolation/communication valve or past the seals of the floating piston (into the sample). The latter being of particular importance as it would “contaminate” the sample.

While pressure equilibrium is expected across the various floating pistons of sample bottle 100, elastomeric friction will create a constant pressure differential in a perfect sealing system. Monitoring pressure changes across pistons 114 and 134 (measurements on both ends of the bottle) could provide evidence of gas migration across or through the elastomers during long-term storage and provide evidence to disqualify elemental compensating fluid gas found inside the well fluid sample during analysis. In such scenarios, the sample would become contaminated but such contamination could be detected by observing pressure loss in the compensating fluid pressure, while observing pressure increase in the sample. The benefit of such understanding is non-trivial when detailed sample compositional analysis is required/necessary to plan for production process/separation facilities. Furthermore, sensor packages on both ends of bottle 100 could also be used as a redundancy measure in case of damage to a primary sensor package.

The use of capacitance or other suitable sensor types will also enable compositional analysis of bottle contents. For example, a sensor package including a capacitance device mounted on the sample side of the bottle (adjacent sample chamber 116 as illustrated) would be used in a similar manner as in downhole wireline/logging tools. Namely, measurement of the composition of the captured sample. Immediately after fluid sampling, it can be difficult to know the water cut of the obtained sample with any accuracy, especially in wells with slugging flow. Since a minimum hydrocarbon volume is necessary for adequate analysis, knowing the approximate water/oil ratio in obtained samples is critical information for making the decision on additional sampling runs or not. The capacitance sensor will enable this analysis. Also, the capacitance device offers value in situations when the sample must be rocked (homogenized) prior to analysis. The conventional approach has been to rock the bottle for an arbitrarily long time. However, the capacitance sensor of the present disclosure may be used to identify a stabilization point of the fluid contained within and, hence, when an adequate amount of homogenization has occurred.

Referring still to FIG. 2, sensor package 15 is communicably coupled to a display module 17 located on end cap 110a via a wired or wireless connection. During operation, a technician may press various buttons on the display module in order to obtain well fluid characteristic data and have it displayed at a given time. This enables technicians to readily observe the pressure/temperature of the bottle contents without rigging up a manifold or opening/closing bottle valves. Also, in certain embodiments, the memory device may form part of display module 17.

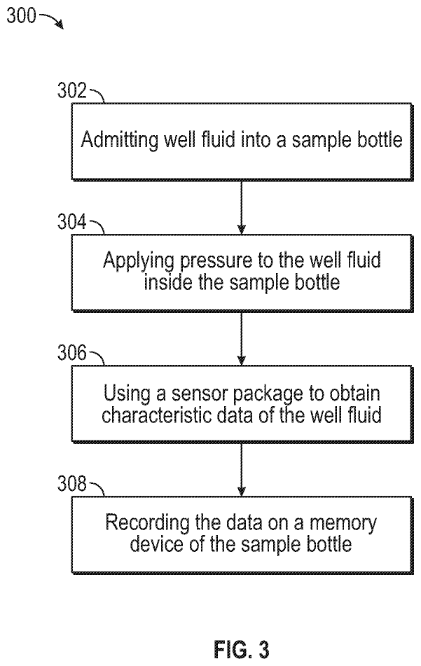

FIG. 3 is a flow chart of a method 300 of using the sample bottles, according to certain illustrative methods of the present disclosure. At block 302, well fluid is admitted into the sample bottle. At block 304, pressure is applied and/or maintained on the fluid sample using various components of the sample bottle. At block 306, the sensor package(s) of the sample bottle are used to obtain data of the fluid sample or bottle. At block 308, that data is then recorded on a memory device also positioned on/within the sample bottle.

During operation of the illustrative sample bottles described herein, a system status check may be conducted at any time. During such checks, the status of each sensor of sensor package 15 may be polled to obtain characteristic data of the fluid sample and/or sample bottle. Examples of such data include pressure and position of floating pistons. In certain examples, the data may be obtained using a “push button” option of the display module, which would not necessitate a download of data from any auxiliary equipment (or any need to connect thereto). In response to the push of a button, the characteristic data will be displayed on display module 17. Alternatively, the characteristic data may be transmitted (wired/wirelessly) to some remote device (handheld device, for example) where the data may be read by a technician. This data may be used to generate a report of the well fluid transport history from a well to the laboratory. Through analysis of the data, a technician can determine if the sample bottle has been compromised or otherwise tampered with during transfer. In some cases, for example, a sudden pressure spike or other anomaly might be used to indicate tampering or user error.

Moreover, in other examples, sensor package 15 may be programmed with alarm limits that trigger when certain thresholds are exceeded. For example, if the sensor package detects that pressure inside the bottle has dropped below a programmed limit (or some other pressure anomaly), display module 17 may initiate an alarm (red LED, for example) indicating an alarm event inside the bottle has occurred, so just by visual inspection, one would have an understanding of a most important measurement while the sample is in the bottle (pressure). Alternatively, the alarms may be set for various other data characteristics (temperature, volume, etc.) and/or audible alarms may be implemented.

Accordingly, embodiments of the present disclosure provide many advances over conventional sample bottles used to transfer pressurized well fluid. First, for example, the bottles offer verifiable, tamper-resistant pressure and temperature history on fluid samples with the push of a button. A “verified” sample is a superior product to a “traditional” sample (one that technicians did not know the transport history of a sample or if sample had been tampered with or where such tampering would have occurred). Second, the bottles offer a significant safety upgrade because technicians do not have to open the bottle to know the internal pressure. Third, the bottles assist in decision making on rigsite because the quantity of the oil sample obtained can be known with much more certainty. Fourth, the bottles reduce time wasted excessively rocking sample when the fluid is already homogenized (because technicians can readily know the composition of the sample using the display module).

Embodiments and methods described herein further relate to any one or more of the following paragraphs:

1. A method for use with a sample bottle for the transfer of pressurized well fluid, the method comprising admitting well fluid into a fluid sample chamber of the sample bottle; applying pressurization to the well fluid in a manner which maintains the well fluid in a pressurized state; using a sensor package positioned on or inside the sample bottle, obtaining data related to one or more characteristics of the well fluid in the fluid sample chamber; and recording the data using a memory device communicably coupled to the sensor package.

2. The method as defined in paragraph 1, further comprising displaying the data using a display module on an outer surface of the sample bottle.

3. The method as defined in paragraphs 1 or 2, further comprising using the data recorded by the memory device, determining whether the well fluid is undergoing a dynamic process; and in response to the determination, adjusting a data sampling rate of the sensor package.

4. The method as defined in any of paragraphs 1-3, further comprising powering the sensor package using one or more batteries.

5. The method as defined in any of paragraphs 1-4, wherein obtaining the data comprises obtaining at least one of a density, volume, pressure, temperature, capacitance or resistance measurement.

6. The method as defined in any of paragraphs 1-5, further comprising wirelessly transmitting the data to a device remote from the sample bottle.

7. The method as defined in any of paragraphs 1-6, wherein the sensor package comprises a capacitance sensor; and the method further comprises connecting the capacitance sensor to a power source external to the sample bottle; in response to the connection, activating the capacitance sensor; and writing data from the capacitance sensor to the memory device.

8. The method as defined in any of paragraphs 1-7, further comprising using a position sensor on a floating piston inside the sample bottle to obtain a volume measurement of the well fluid in the fluid sample chamber.

9. The method as defined in any of paragraphs 1-8, further comprising using the data to generate a report of the well fluid transport history from a well to a laboratory.

10. The method as defined in any of paragraphs 1-9, further comprising in response to the data obtained by the sensor package, detecting an alarm event has occurred inside the sample bottle; and triggering an alarm in response to the detection.

11. The method as defined in any of paragraphs 1-10, wherein the alarm event is the detection of a pressure anomaly.

12. A sample bottle for the transfer of pressurized well fluid, comprising a housing having a fluid sample inlet port; a chamber in fluid communication with the fluid sample inlet port to receive a well fluid; a sensor package positioned on or inside the bottle; and a memory device communicably coupled to the sensor package.

13. The sample bottle as defined in paragraph 12, further comprising a display module communicably coupled to the memory device to thereby display data received from the sensor package.

14. The sample bottle as defined in paragraphs 12 or 13, wherein the sensor package comprises at least one of a density, volume, pressure, temperature, capacitance or resistance sensor.

15. The sample bottle as defined in any of paragraphs 12-14, further comprising a floating piston slidably disposed inside the chamber to separate the chamber into a fluid sample chamber on one side of the floating piston and a pressurization chamber on an opposite side of the floating piston, the fluid sample chamber containing the well fluid; a pressurization source in fluid communication with the pressurization source connection and the pressurization chamber to thereby apply pressure to the floating piston sufficient to maintain the well fluid in a pressurized state; and a position sensor attached to the floating piston.

16. The sample bottle as defined in any of paragraphs 12-15, wherein the memory device is embedded into the housing.

17. The sample bottle as defined in any of paragraphs 12-16, wherein the memory gauge is battery-operated.

Although various embodiments and methods have been shown and described, the disclosure is not limited to such embodiments and methods and will be understood to include all modifications and variations as would be apparent to one skilled in the art. Therefore, it should be understood that embodiments of the disclosure are not intended to be limited to the particular forms disclosed. Rather, the intention is to cover all modifications, equivalents and alternatives falling within the spirit and scope of the disclosure as defined by the appended claims.

What is claimed is:

1. A method for use with a sample bottle for the transfer of pressurized well fluid, the method comprising:
admitting well fluid into a fluid sample chamber of the sample bottle;
applying pressurization to the well fluid in a manner which maintains the well fluid in a pressurized state;
using a sensor package positioned on or inside the sample bottle, obtaining data related to one or more characteristics of the well fluid in the fluid sample chamber; and
recording the data using a memory device communicably coupled to the sensor package.

2. The method as defined in claim 1, further comprising displaying the data using a display module on an outer surface of the sample bottle.

3. The method as defined in claim 1, further comprising:
is using the data recorded by the memory device, determining whether the well fluid is undergoing a dynamic process; and
in response to the determination, adjusting a data sampling rate of the sensor package.

4. The method as defined in claim 1, further comprising powering the sensor package using one or more batteries.

5. The method as defined in claim 1, wherein obtaining the data comprises obtaining at least one of a density, volume, pressure, temperature, capacitance or resistance measurement.

6. The method as defined in claim 1, further comprising wirelessly transmitting the data to a device remote from the sample bottle.

7. The method as defined in claim 1, wherein:
the sensor package comprises a capacitance sensor; and
the method further comprises:
connecting the capacitance sensor to a power source external to the sample bottle;
in response to the connection, activating the capacitance sensor; and
writing data from the capacitance sensor to the memory device.

8. The method as defined in claim 1, further comprising using a position sensor on a floating piston inside the sample bottle to obtain a volume measurement of the well fluid in the fluid sample chamber.

9. The method as defined in claim 1, further comprising using the data to generate a report of the well fluid transport history from a well to a laboratory.

10. The method as defined in claim 1, further comprising:
in response to the data obtained by the sensor package, detecting an alarm event has occurred inside the sample bottle; and
triggering an alarm in response to the detection.

11. The method as defined in claim 1, wherein the alarm event is the detection of a pressure anomaly.

12. A sample bottle for the transfer of pressurized well fluid, comprising:
a housing having a fluid sample inlet port;
a chamber in fluid communication with the fluid sample inlet port to receive a well fluid;
a sensor package positioned on or inside the bottle; and
a memory device communicably coupled to the sensor package.

13. The sample bottle as defined in claim 12, further comprising a display module communicably coupled to the memory device to thereby display data received from the sensor package.

14. The sample bottle as defined in claim 12, wherein the sensor package comprises at least one of a density, volume, pressure, temperature, capacitance or resistance sensor.

15. The sample bottle as defined in claim 12, further comprising:
a floating piston slidably disposed inside the chamber to separate the chamber into a fluid sample chamber on one side of the floating piston and a pressurization chamber on an opposite side of the floating piston, the fluid sample chamber containing the well fluid;
a pressurization source in fluid communication with the pressurization source connection and the pressurization chamber to thereby apply pressure to the floating piston sufficient to maintain the well fluid in a pressurized state; and
a position sensor attached to the floating piston.

16. The sample bottle as defined in claim 12, wherein the memory device is embedded into the housing.

17. The sample bottle as defined in claim 1, wherein the memory gauge is battery-operated.
